(19) United States
(12) Patent Application Publication
(10) Pub. No.: US 2019/0160857 A1
(43) Pub. Date: May 30, 2019

(54) THERMAL TRANSFER APPARATUS

(71) Applicant: DGSHAPE Corporation, Hamamatsu-shi (JP)

(72) Inventor: Takuya HAYASHI, Hamamatsu-shi (JP)

(21) Appl. No.: 16/185,040

(22) Filed: Nov. 9, 2018

(30) Foreign Application Priority Data
Nov. 30, 2017 (JP) 2017-230177

(51) Int. Cl. B44C 1/17

(52) U.S. Cl. CPC B44C 1/1716

(57) ABSTRACT

A thermal transfer apparatus includes a fixture that holds a transfer object, a pressing body that presses a thermal transfer foil placed on the transfer object, and a light source with a light output that varies depending on a temperature and which applies heat to the thermal transfer foil pressed by the pressing body, and also includes a foil transfer tool that transfers the thermal transfer foil onto a transfer object and a pressing body moving mechanism that moves the pressing body relative the fixture, and a fan that sends air to the light source.

### CROSS REFERENCE TO RELATED APPLICATIONS

This application claims the benefit of priority to Japanese Patent Application No. 2017-230177 filed on Nov. 30, 2017. The entire contents of this application are hereby incorporated herein by reference.

### BACKGROUND OF THE INVENTION

### 1. Field of the Invention

The present invention relates to a thermal transfer apparatus. In particular, the present invention relates to a thermal transfer apparatus that transfers foil onto a transfer object using thermal transfer foil.

### 2. Description of the Related Art

A decorative process by a heat transfer technique using thermal transfer foil (also called a heat transfer sheet) has been performed to date for purposes such as enhancement of aesthetic design. The thermal transfer foil is generally constituted by stacking a base material, a decorative layer, and an adhesive layer in this order. In transfer (i.e., transfer of thermal transfer foil to a transfer object), thermal transfer foil is overlaid on the transfer object such that an adhesive layer of the foil contacts the transfer object, and the thermal transfer foil is heated by applying light to the thermal transfer foil while the thermal transfer foil from above is pressed with a foil transfer tool (e.g., a laser pen) including a light source for applying light (e.g., laser light). Accordingly, the adhesive layer in a pressed portion of the thermal transfer foil is melted and attached to the surface of the transfer object, and then is cured by heat dissipation. Consequently, the base material of the thermal transfer foil is separated from the transfer object so that a decorative layer having a shape corresponding to the portion stamped with foil can be attached to the transfer object together with the adhesive layer. In this manner, the surface of the transfer object is provided with a decoration of foil having an intended shape (e.g., a figure or a character).

Japanese Patent No. 5926083, for example, discloses a technique of transferring foil to a transfer object using a foil transfer tool that applies laser light.

A light source for use in transferring thermal transfer foil onto a transfer object has a property in which an output (i.e., the quantity of light) varies depending on the temperature of the light source itself even when a constant amount of current is supplied to the light source. During transfer, the temperature of the light source gradually increases because of heat generated by the light source itself, and thus, the output of the light source might decrease below a design value. When transfer of the thermal transfer foil continues with a reduced output of the light source, the thermal transfer foil does not sufficiently adhere to the transfer object, resulting in the possibility of a failure in accurately transferring the thermal transfer foil onto the transfer object.

### SUMMARY OF THE INVENTION

In view of the foregoing circumstances, preferred embodiments of the present invention provide thermal transfer apparatuses each capable of transferring foil onto a transfer object more accurately.

A thermal transfer apparatus according to a preferred embodiment of the present invention includes a stand that holds a transfer object; a foil transfer tool including a pressing body that presses thermal transfer foil placed on the transfer object, and a light source that provides a light output that varies depending on a temperature and supplies heat to the thermal transfer foil pressed by the pressing body, the foil transfer tool being structured to transfer the thermal transfer foil onto the transfer object; a moving mechanism that moves one of the stand and the pressing body relative to another of the stand and the pressing body; and a fan that sends air to the light source.

A thermal transfer apparatus according to a preferred embodiment of the present invention includes the fan that sends air to the light source with a light output that varies depending on the temperature. Thus, air is sent toward the light source during transfer to enable cooling of the light source. Accordingly, an increase in temperature of the light source is able to be reduced or prevented, and thus, the temperature of the light source itself during transfer is able to be kept within a predetermined temperature range. As a result, an output of the light source is able to be maintained constant or substantially constant, and thus, the thermal transfer foil is able to be more accurately transferred onto the transfer object.

The preferred embodiments of the present invention provide thermal transfer apparatuses each capable of transferring foil onto transfer objects more accurately.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically illustrating a thermal transfer apparatus according to a preferred embodiment of the present invention.

FIG. 2 is a partially broken perspective view schematically illustrating a thermal transfer apparatus according to a preferred embodiment of the present invention.

FIG. 3 is a left side view schematically illustrating a pressing body moving mechanism according to a preferred embodiment of the present invention.

FIG. 4 is a perspective view illustrating a peripheral configuration of an elevation base according to a preferred embodiment of the present invention.

FIG. 5 is a cross-sectional view schematically illustrating a configuration of a foil transfer tool according to a preferred embodiment of the present invention.

FIG. 6 is a block diagram illustrating a configuration of a power supply around a light source according to a preferred embodiment of the present invention.

FIG. 7 is a block diagram of a thermal transfer apparatus according to a preferred embodiment of the present invention.

### DETAILED DESCRIPTION OF THE PREFERRED EMBODIMENTS

Preferred embodiments of the present invention will be described hereinafter with reference to the drawings. The preferred embodiments described here are, of course, not intended to particularly limit the present invention. Elements and features having the same functions are denoted by the same reference numerals, and description for the same members and parts will not be repeated or will be simplified as appropriate.

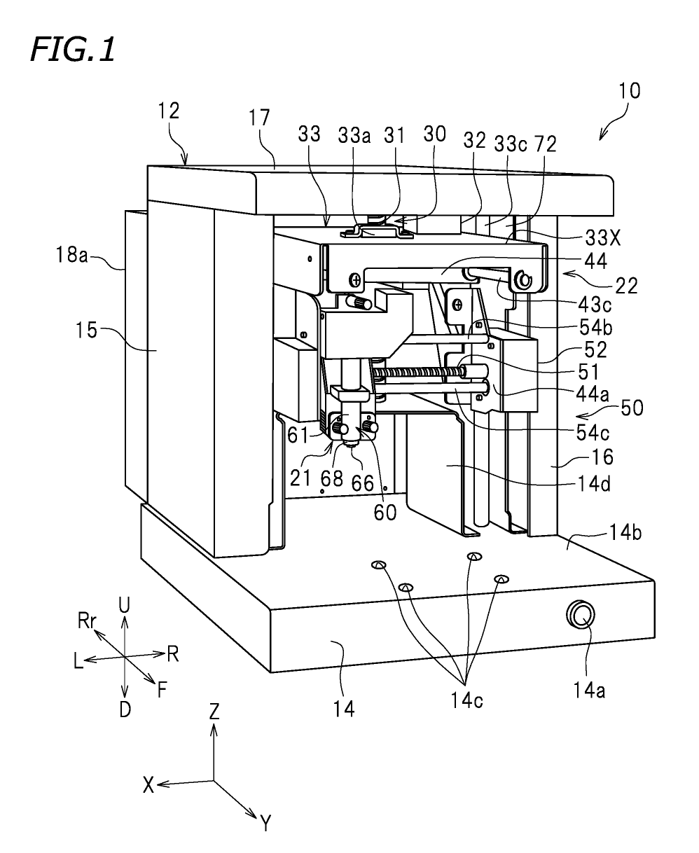

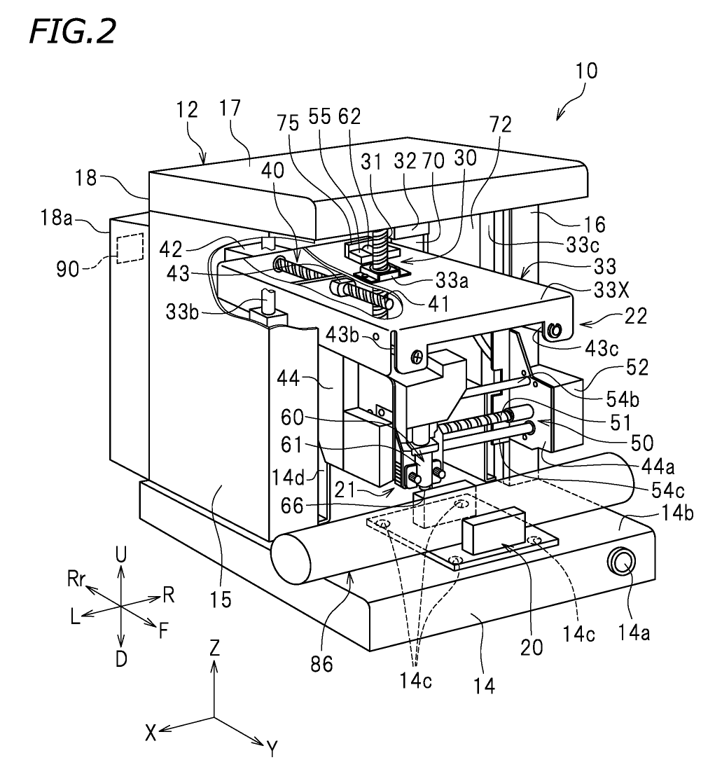

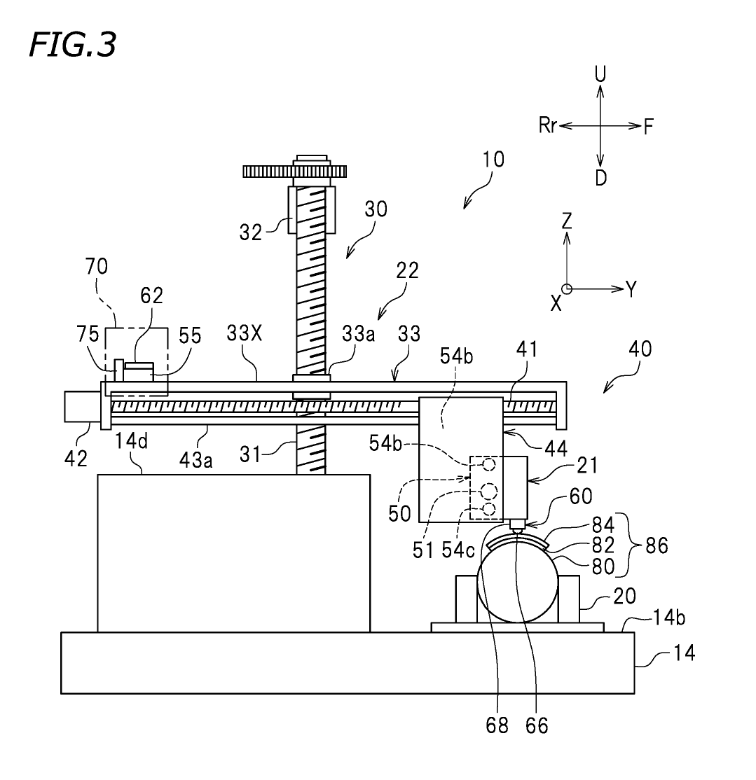

First, a configuration of a thermal transfer apparatus 10 according to a first preferred embodiment of the present invention will be described. FIG. 1 is a perspective view schematically illustrating the thermal transfer apparatus 10. FIG. 2 is a partially broken perspective view schematically illustrating an aspect of the thermal transfer apparatus 10. FIG. 3 is a left side view schematically illustrating a pressing body moving mechanism 22 during transfer. In the following description, left, right, up, and down refer to left, right, up, and down, respectively, when an operator (user) in front of the thermal transfer apparatus 10 sees a power supply switch 14a. When seen from the operator, a direction toward the thermal transfer apparatus 10 will be referred to as rearward, and a direction away from the thermal transfer apparatus 10 will be referred to as forward. Characters F, Rr, L, R, U, and D in the drawings represent front, rear, left, right, up, and down, respectively. Suppose axes orthogonal to one another are an X axis, a Y axis, and a Z axis, the thermal transfer apparatus 10 according to this preferred embodiment is placed on a plane constituted by the X axis and the Y axis. Here, the X axis extends leftward and rightward. The Y axis extends forward and rearward. The Z axis extends upward and downward. It should be noted that these directions are defined simply for convenience of description, and do not limit the state of installation of the thermal transfer apparatus 10.

As illustrated in FIG. 3, the thermal transfer apparatus 10 is an apparatus that applies a decorative layer in a sheet-shaped thermal transfer foil 82 to a surface of transfer object 80 by pressing and heating the thermal transfer foil 82 and a light absorption film 84 by using a foil transfer tool 60 described later with the thermal transfer foil 82 and the light absorption film 84 overlaid on the transfer object 80. The thermal transfer foil 82 is indirectly pressed against the foil transfer tool 60 with the light absorption film 84 interposed therebetween. With some combinations of the transfer object 80 and the thermal transfer foil 82, the light absorption film 84 may be omitted. In the following description, objects of “pressing and heating,” such as the transfer object 80, the thermal transfer foil 82, and the light absorption film 84, will be collectively referred to as a process object 86.

The transfer object 80 is not limited to a specific material and a specific shape. Examples of materials for the transfer object 80 include metals such as gold, silver, copper, platinum, brass, aluminum, iron, titanium, and stainless, resins such as acrylic, polyvinyl chloride (PVC), polyethylene terephthalate (PET), and polycarbonate (PC), papers such as plain paper, drawing paper, and Japanese paper, and rubbers.

The thermal transfer foil 82 may be, but is not limited to, transfer foil commercially available for heat transfer. The thermal transfer foil 82 is typically a stack of a base material, a decorative layer, and an adhesive layer in this order. The decorative layer in the thermal transfer foil 82 includes, for example, metallic foil such as gold foil and sliver foil, half metallic foil, pigment foil, multi-color printing foil, hologram foil, and electrostatic destruction measures foil. The thermal transfer foil 82 has a band shape or a sheet shape. The thermal transfer foil 82 is placed on the transfer object 80. The thermal transfer foil 82 may further include a light absorption layer between the base material and the decorative layer. In the case where the thermal transfer foil 82 includes the light absorption layer, the base material is made of a transparent material. The light absorption layer has a configuration similar to that of the light absorption film 84 described later. In the case where the thermal transfer foil 82 includes the light absorption layer, the thermal transfer apparatus 10 does not need to include the light absorption film 84 in some cases. Even in the case where the thermal transfer foil 82 includes the light absorption layer, the thermal transfer apparatus 10 preferably includes the light absorption film 84.

Some configurations of the thermal transfer foil 82 to be used may have no or poor light absorption property to light applied from a light source 62 of the foil transfer tool 60 described later. In such cases, the light absorption film 84 can be overlaid on top of the thermal transfer foil 82 and used as the process object 86. The light absorption film 84 refers to a sheet structured to efficiently absorb light in a predetermined wavelength range (e.g., laser light) applied from the light source 62 of the foil transfer tool 60 and capable of converting optical energy to thermal energy. The light absorption film 84 preferably has a heat resistance at about 100° C. to about 200° C., for example. The light absorption film 84 preferably is made of a resin such as polyimide, for example. The light absorption film 84 preferably is monochrome, for example. From the viewpoint of efficiently converting optical energy to thermal energy, the hue of the light absorption film 84 is preferably complementary to the color of light (e.g., laser light) applied from the light source 62. For example, in a case where light (e.g., laser light) from the light source 62 is blue, the light absorption film 84 is preferably yellow. The light absorption film 84 may be provided with a protective film to increase strength as necessary. The protective film preferably has a light absorption property significantly lower than that of the light absorption film 84. The protective film preferably has a light transmittance higher than that of the light absorption film 84, and is, for example, transparent. The protective film is not limited to a specific material. The protective film is preferably defined by a plastic film such as polyester, for example.

As illustrated in FIG. 1, the thermal transfer apparatus 10 preferably has a box shape, for example. The thermal transfer apparatus 10 includes a housing 12 that is open at the front, a pressing body moving mechanism 22 disposed in the housing 12, a carriage 21, and the foil transfer tool 60. The housing 12 includes a bottom wall 14, a left side wall 15, a right side wall 16, an upper wall 17, and a rear wall 18 (see FIG. 2). The housing 12 is preferably made of a steel plate, for example.

As illustrated in FIG. 2, a fixture 20 such as a vice is detachably attached to the bottom wall 14. The fixture 20 is a stand that holds the transfer object 80 (i.e., the process object 86). A front region of the bottom wall 14 is a fixture placing region 14b to place the fixture 20. A center portion of the fixture placing region 14b preferably includes four attachment holes 14c to attach the fixture 20, for example. A front surface of the bottom wall 14 is provided with the power supply switch 14a.

As illustrated in FIG. 2, the left side wall 15 extends upward at the left end of the bottom wall 14. The left side wall 15 is perpendicular or substantially perpendicular to the bottom wall 14. The right side wall 16 extends upward at the right end of the bottom wall 14. The right side wall 16 is perpendicular or substantially perpendicular to the bottom wall 14. The rear wall 18 extends upward at the rear end of the bottom wall 14. The rear wall 18 is connected to the rear end of the left side wall 15 and the rear end of the right side wall 16. The rear wall 18 is provided with a box-shaped case 18a. The case 18a houses a controller 90 described later. The upper wall 17 is connected to the upper end of the left side wall 15, the upper end of the right side wall 16, and the upper end of the rear wall 18. A portion of a first moving mechanism 30 described later of the pressing body moving mechanism 22 is disposed on the upper wall 17. A region surrounded by the bottom wall 14, the left side wall 15, the right side wall 16, the upper wall 17, and the rear wall 18 is internal space of the housing 12.

The internal space of the housing 12 is a space where the thermal transfer foil 82 is transferred onto the transfer object 80. The pressing body moving mechanism 22 is provided in an internal space. That is, the pressing body moving mechanism 22 is housed in the housing 12. The pressing body moving mechanism 22 is an example of the moving mechanism. The pressing body moving mechanism 22 includes a carriage 21, the first moving mechanism 30 that moves the carriage 21 along the Z axis, a second moving mechanism 40 that moves the carriage 21 along the Y axis, and a third moving mechanism 50 that moves the carriage 21 along the X axis. The carriage 21 is disposed below an elevation base 33 described later. The pressing body moving mechanism 22 moves the carriage 21 in three dimensions. The carriage 21 is movable relative to the fixture 20 (i.e., the process object 86) by the first moving mechanism 30, the second moving mechanism 40, and the third moving mechanism 50. That is, the pressing body moving mechanism 22 moves a pressing body 66 mounted on the carriage 21 relative to the fixture 20. The first moving mechanism 30, the second moving mechanism 40, and the third moving mechanism 50 are disposed above the bottom wall 14.

As illustrated in FIG. 1, the first moving mechanism 30 moves the carriage 21 along the Z axis (upward and downward). That is, the first moving mechanism 30 moves the pressing body 66 of the foil transfer tool 60 disposed on the carriage 21 along the Z axis. The first moving mechanism 30 preferably includes a feed screw mechanism including a Z-axis feed screw rod 31, a Z-axis feed motor 32, and a feed nut 33a. The Z-axis feed screw rod 31 extends along the Z axis. The Z-axis feed screw rod 31 includes a helical screw groove. An upper portion of the Z-axis feed screw rod 31 is fixed to the upper wall 17. An upper end portion of the Z-axis feed screw rod 31 penetrates the lower surface of the upper wall 17 along the Z axis, and is partially disposed inside the upper wall 17. A lower end portion of the Z-axis feed screw rod 31 is rotatably supported on a frame 14d (see also FIG. 3). The frame 14d is fixed onto the bottom wall 14. The Z-axis feed motor 32 is an electric motor. The Z-axis feed motor 32 is connected to the controller 90 (see FIG. 2). The Z-axis feed motor 32 is fixed to the upper wall 17. A driving shaft of the Z-axis feed motor 32 penetrates the lower surface of the upper wall 17 along the Z axis and is partially disposed inside the upper wall 17. In the upper wall 17, the Z-axis feed screw rod 31 is coupled to the Z-axis feed motor 32. The Z-axis feed motor 32 causes the Z-axis feed screw rod 31 to rotate.

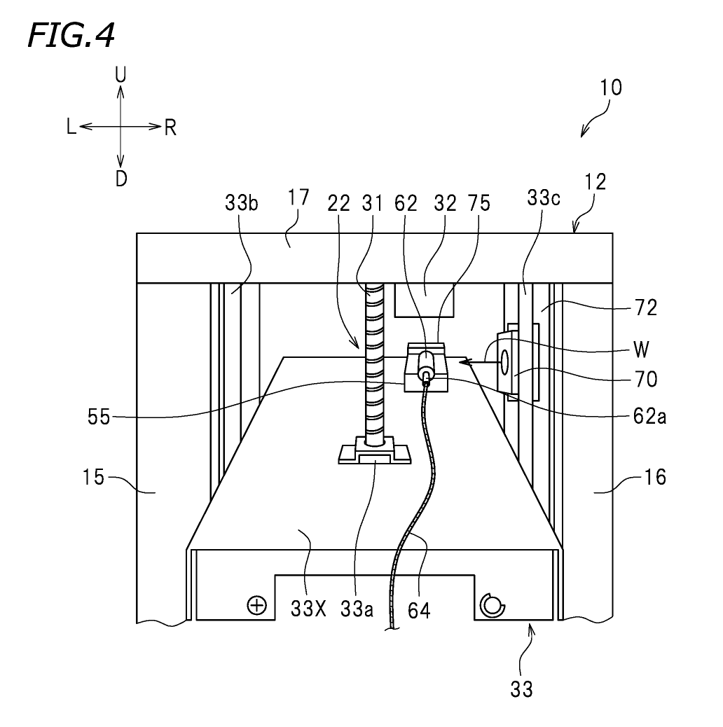

As illustrated in FIG. 2, the feed nut 33a including a screw thread is engaged with the Z-axis feed screw rod 31. The feed nut 33a is coupled to an elevation base 33. The elevation base 33 is an example of a base member. The feed nut 33a penetrates the upper surface of the elevation base 33 along the Z axis. The elevation base 33 is supported on the Z-axis feed screw rod 31 with the feed nut 33a interposed therebetween. The elevation base 33 is parallel or substantially parallel to the bottom wall 14. The lengths of the elevation base 33 along the X axis and the Y axis are larger than the lengths of the fixture placing region 14b along the X axis and the Y axis. As illustrated in FIG. 4, slide shafts 33b and 33c each extending along the Z axis are provided at the inner sides of the left side wall 15 and the right side wall 16. The slide shafts 33b and 33c are parallel or substantially parallel to the Z-axis feed screw rod 31. The slide shafts 33b and 33c are disposed to enable the elevation base 33 to slide along the Z axis. When the Z-axis feed motor 32 is driven, rotation of the Z-axis feed screw rod 31 causes the elevation base 33 to move up and down along the slide shafts 33b and 33c. The second moving mechanism 40 and the third moving mechanism 50 are coupled to the elevation base 33. Thus, the second moving mechanism 40 and the third moving mechanism 50 integrally move up and down with upward and downward movement of the elevation base 33. The carriage 21 moves up and down with upward and downward movement of the elevation base 33.

As illustrated in FIG. 2, the second moving mechanism 40 moves the carriage 21 along the Y axis (forward and rearward). That is, the second moving mechanism 40 moves the pressing body 66 of the foil transfer tool 60 disposed on the carriage 21 along the Y axis. The second moving mechanism 40 preferably includes a feed screw mechanism including a Y-axis feed screw rod 41, a Y-axis feed motor 42, and a feed nut 43. The Y-axis feed screw rod 41 extends along the Y axis. The Y-axis feed screw rod 41 is disposed on the elevation base 33. The Y-axis feed screw rod 41 has a helical screw groove. A rear end portion of the Y-axis feed screw rod 41 is coupled to the Y-axis feed motor 42. The Y-axis feed motor 42 is an electric motor. The Y-axis feed motor 42 is connected to the controller 90. The Y-axis feed motor 42 is fixed to the rear of the elevation base 33. The Y-axis feed motor 42 causes the Y-axis feed screw rod 41 to rotate. A feed nut 43 including a screw thread is engaged with a screw groove of the Y-axis feed screw rod 41. A pair of slide shafts 43b and 43c extending along the Y axis is disposed on the elevation base 33. The two slide shafts 43b and 43c are parallel or substantially parallel to the Y-axis feed screw rod 41. A slide base 44 is provided on the slide shafts 43b and 43c to be slidable along the Y axis. When the Y-axis feed motor 42 is driven, rotation of the Y-axis feed screw rod 41 causes the slide base 44 to move forward and rearward along the slide shafts 43b and 43c.

As illustrated in FIG. 1, the third moving mechanism 50 moves the carriage 21 along the X axis (leftward and rightward). That is, the third moving mechanism 50 moves the pressing body 66 of the foil transfer tool 60 disposed on the carriage 21 along the X axis. The third moving mechanism 50 preferably includes a feed screw mechanism including an X-axis feed screw rod 51, an X-axis feed motor 52, and an unillustrated feed nut. The X-axis feed screw rod 51 extends along the X axis. The X-axis feed screw rod 51 is disposed ahead of the slide base 44. The X-axis feed screw rod 51 includes a helical screw groove. An end of the X-axis feed screw rod 51 is coupled to the X-axis feed motor 52. The X-axis feed motor 52 is an electric motor. The X-axis feed motor 52 is connected to the controller (see FIG. 2). The X-axis feed motor 52 is disposed ahead of the slide base 44 and is fixed to a plate member 44a extending forward. The X-axis feed motor 52 causes the X-axis feed screw rod 51 to rotate. A feed nut including a screw thread is engaged with a screw groove of the X-axis feed screw rod 51. A pair of slide shafts 54b and 54c extending along the X axis is disposed ahead of the slide base 44. The two slide shafts 54b and 54c are parallel or substantially parallel to the X-axis feed screw rod 51. The carriage 21 is disposed on the slide shafts 54b and 54c to be slidable along the X axis. When the X-axis feed motor 52 is driven, rotation of the X-axis feed screw rod 51 causes the carriage 21 to move leftward and rightward along the slide shafts 54b and 54c.

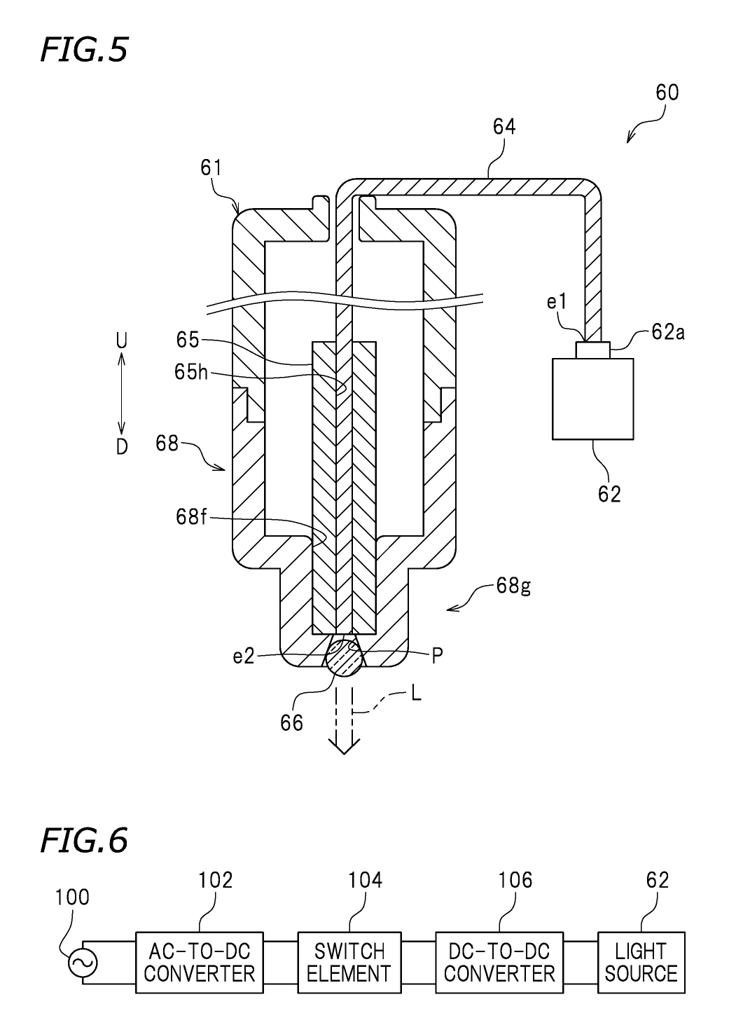

FIG. 5 is a cross-sectional view schematically illustrating the thermal transfer tool 60 according to a preferred embodiment of the present invention. The foil transfer tool 60 presses the thermal transfer foil 82 placed on the transfer object 80 while applying light (e.g., laser light) to the thermal transfer foil 82 to supply heat to the thermal transfer foil 82. In this preferred embodiment, the foil transfer tool 60 presses the thermal transfer foil 82 and the light absorption film 84 while applying laser light to the light absorption film 84 to supply heat to the thermal transfer foil 82. The foil transfer tool 60 transfers the thermal transfer foil 82 onto the transfer object 80. The foil transfer tool 60 is disposed above the fixture 20. The foil transfer tool 60 includes the light source 62, a pen body 61, and the pressing body 66 fixed to the lower end of the pen body 61. The “pressing the thermal transfer foil 82” includes a case where the pressing body 66 of the foil transfer tool 60 contacts the thermal transfer foil 82 to press the thermal transfer foil 82 directly and a case where the pressing body 66 presses the thermal transfer foil 82 indirectly with the light absorption film 84 or a protective film interposed between the pressing body 66 and the thermal transfer foil 82.

The light source 62 supplies heat to the thermal transfer foil 82. The light source 62 applies light serving as a heat source to the light absorption layer of the thermal transfer foil 82 and the light absorption film 84. The light source 62 has a property in which a light output of the light source 62 varies depending on the temperature. Light supplied from the light source 62 to the light absorption layer of the thermal transfer foil 82 and the light absorption film 84 is converted to thermal energy in the light absorption layer and the light absorption film 84 and heats the thermal transfer foil 82. The light source 62 is communicably connected to the controller 90. The light source 62 is controlled by the controller 90. As illustrated in FIG. 4, the light source 62 is disposed on an upper surface 33X of the elevation base 33. The light source 62 is disposed behind the Z-axis feed screw rod 31. The light source 62 is disposed at the right of the Z-axis feed screw rod 31. The light source 62 is housed in a metal case 55. The case 55 is not limited to a specific material, and is made of, for example, aluminum having high thermal conductivity. The case 55 is fixed to the upper surface 33X of the elevation base 33. At least the upper surface of the light source 62 is exposed to the outside from the case 55. Silicone (having a thermal conductivity of about 0.9), for example, is disposed between the light source 62 and the case 55. Accordingly, heat generated by the light source 62 is easily transmitted to the case 55. The light source 62 in the preferred embodiment preferably includes a laser diode (semiconductor laser) that applies laser light and an optical system, for example. Since laser light shows a high response speed, a change in, for example, energy of the laser light as well as switching between application and non-application of the light is able to be performed quickly. Accordingly, laser light having desired properties is able to be applied to the light absorption layer of the thermal transfer foil 82 and the light absorption film 84.

As illustrated in FIG. 1, the pen body 61 is held by the carriage 21. As illustrated in FIG. 5, the pen body 61 has an elongated cylindrical shape. The pen body 61 is oriented to have its longitudinal direction coincide with the upward and downward directions (i.e., the Z axis). The axis of the pen body 61 extends upward and downward. The pen body 61 preferably includes optical fibers 64 and a ferrule 65. The pen body 61 includes a holder 68 described later. The holder 68 is attached to the lower end of the pen body 61.

The optical fibers 64 define an optical transfer medium that transfers light applied from the light source 62. The optical fibers 64 include a core portion (not shown) through which light passes and a cladding portion (not shown) that surrounds the core portion and reflects light. The optical fibers 64 are connected to the light source 62. The optical fibers 64 include an upper end e1 extending to the outside of the pen body 61. The end e1 of the optical fibers 64 is inserted in a connector 62a included in the light source 62. With this configuration, the optical fibers 64 are connected to the light source 62 with a reduced optical loss. The optical fibers 64 include a lower end e2 equipped with the ferrule 65. The ferrule 65 is a cylindrical optical photojunction member. The ferrule 65 has a through hole 65h extending along the cylindrical axis. The end e2 of the optical fibers 64 is inserted in the through hole 65h of the ferrule 65. The optical fibers 64 are an example of a light guide.

As illustrated in FIG. 5, the pen body 61 is provided with the holder 68. The holder 68 is a holding member disposed at the lower end of the pen body 61 and used to hold the ferrule 65 at a predetermined position. The holder 68 preferably has a cap shape, for example. An upper portion of the holder 68 preferably has a cylindrical shape with an outer diameter that corresponds to the pen body 61. A lower portion of the holder 68 includes a cylindrical projection 68g with an outer diameter that is smaller than that of the pen body 61. The projection 68g includes a ferrule holding portion 68f that is a cylindrical recess. The ferrule holding portion 68f has an inner diameter corresponding to the outer diameter of the ferrule 65. The ferrule holding portion 68f houses the lower end of the ferrule 65.

The holder 68 has an aperture P penetrating the holder 68 upward and downward. The core portion of the end e2 of the optical fibers 64 is exposed to the outside through the aperture P. That is, in bottom view, the core portion of the end e2 of the optical fibers 64 overlaps the aperture P. Accordingly, the holder 68 does not interfere with an optical path L of laser light. Consequently, laser light applied from the light source 62 is able to be emitted to the outside from the lower end of the pan body 61.

The holder 68 also holds the pressing body 66 at a predetermined position on the lower end of the pen body 61. The pressing body 66 presses the thermal transfer foil 82 placed on the transfer object 80. The pressing body 66 presses the thermal transfer foil 82 with downward movement of the elevation base 33. In this preferred embodiment, the pressing body 66 further presses the light absorption film 84. The pressing body 66 is detachably provided in the holder 68. In this preferred embodiment, the pressing body 66 preferably is spherical, for example. The pressing body 66 preferably is made of a hard material, for example. The pressing body 66 is not strictly limited to a specific hardness, and is made of, for example, a material having a Vickers hardness of about 100 HV0.2 or more (e.g., about 500 HV0.2 or more). The holder 68 holds the pressing body 66 on the optical path L of laser light. The pressing body 66 preferably is made of a material through which laser light emitted from the light source 62 passes.

Accordingly, even in a case where the pressing body 66 is disposed on the optical path L, laser light passes through the pressing body 66. The pressing body 66 may be made of, for example, glass. The pressing body 66 according to the present preferred embodiment may be made of synthetic quartz glass.

As illustrated in FIG. 4, the thermal transfer apparatus 10 includes a fan 70. The fan 70 sends air to the light source 62 as indicated by arrow W in FIG. 4. The fan 70 agitates air in a space surrounded by the upper wall 17, the left side wall 15, a separation plate 72 described later, and the elevation base 33 in the internal space of the housing 12. The fan 70 is provided in the housing 12. The fan 70 is provided in the separation plate 72 in the housing 12. The separation plate 72 is disposed at the left of the right side wall 16. The space is defined between the separation plate 72 and the right side wall 16. The separation plate 72 is disposed at the right of the elevation base 33. The separation plate 72 preferably is made of, for example, aluminum. The fan 70 is disposed behind the slide shaft 33c. The fan 70 is disposed at a side of the light source 62. In this preferred embodiment, the fan 70 is disposed at the right of the light source 62. As illustrated in FIG. 3, at least a portion of the fan 70 is preferably disposed at a position overlapping with the light source 62 in side view when the pressing body 66 presses the thermal transfer foil 82. The fan 70 is communicably connected to the controller 90. The fan 70 is controlled by the controller 90. The fan 70 is not limited to a specific type, and may be an axial flow fan or a blower fan, for example. The fan 70 is not limited to a specific location, and may be disposed at a side of the light source 62 and above the elevation base 33, for example. The fan 70 may be disposed on the lower surface of the upper wall 17 of the housing 12 at a position facing the light source 62.

As illustrated in FIG. 4, the thermal transfer apparatus 10 includes a temperature measurement device 75. The temperature measurement device 75 measures the temperature of the light source 62. The temperature measurement device 75 is communicably connected to the controller 90, and temperature information on the light source 62 is transmitted to the controller 90. The temperature measurement device 75 is disposed on the elevation base 33. The temperature measurement device 75 is disposed behind the light source 62. The temperature measurement device 75 is provided in the case 55. The temperature measurement device 75 is not limited to a specific type, and may be a thermistor, for example.

The term “transparent” as used herein means that a transmittance of laser light to the pressing body 66 is about 50% or more, preferably about 70% or more, more preferably about 80% or more, and especially more preferably about 85% or more (e.g., about 90% or more), for example. This transmittance refers to a transmittance including a surface reflection loss of a sample having a predetermined thickness (e.g., about 10 mm) measured in accordance with JIS R3106:1998, for example.

FIG. 6 is a block diagram illustrating a configuration of a power supply around the light source 62. As illustrated in FIG. 6, the thermal transfer apparatus 10 includes an AC-to-DC converter 102, a switch element 104, and a DC-to-DC converter 106. The AC-to-DC converter 102 converts an AC voltage from a commercial power supply 100 to a first DC voltage. The switch element 104 is disposed downstream of the AC-to-DC converter 102. The switch element 104 supplies the first DC voltage from the AC-to-DC converter 102 to the downstream DC-to-DC converter 106 and stops the supply by opening and closing. The switch element 104 is, for example, an interlock power supply shut-off relay. The DC-to-DC converter 106 is disposed downstream of the switch element 104. The DC-to-DC converter 106 reduces the first DC voltage from the AC-to-DC converter 102 to a second DC voltage lower than the first voltage. The light source 62 is disposed downstream of the DC-to-DC converter 106. The light source 62 is supplied with the second voltage generated by the DC-to-DC converter 106.

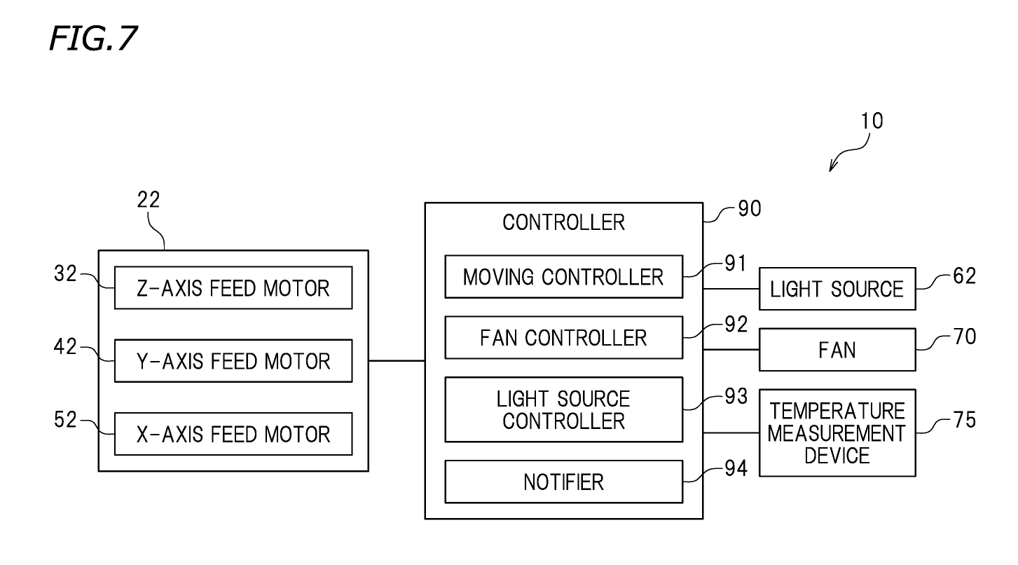

An overall operation of the thermal transfer apparatus 10 is controlled by the controller 90. As illustrated in FIG. 7, the controller 90 is communicably connected to the pressing body moving mechanism 22, the light source 62, and the fan 70 and is configured or programmed to enable control of the pressing body moving mechanism 22, the light source 62, and the fan 70. The controller 90 is communicably connected to the Z-axis feed motor 32, the Y-axis feed motor 42, and the X-axis feed motor 52 and is configured or programmed to enable control of these motors. The controller 90 is typically a computer. The controller 90 is configured or programmed to include, for example, an interface (I/F) that receives foil transfer data and other data from external equipment such as a host computer, a central processing unit (CPU) that executes instructions of a control program, a ROM that stores programs to be executed by the CPU, a RAM to be used as a working area where a program is developed, and a memory to store the programs and various types of data.

As illustrated in FIG. 7, a controller 90 is configured or programmed to include a moving controller 91, a fan controller 92, a light source controller 93, and a notifier 94. The functions of these elements of the controller 90 may be implemented by a program. This program may be read from a recording medium such as a CD or a DVD. This program may be downloaded through the Internet. The functions of the elements of the controller 90 may be implemented by, for example, processor(s) and/or circuit(s). Specific control of each of the above-described elements of the controller 90 will be described later.

The moving controller 91 is configured or programmed to cause the pressing body 66 of the foil transfer tool 60 to move relative to the fixture 20 by using the pressing body moving mechanism 22 to press the thermal transfer foil 82 and the light absorption film 84 placed on the transfer object 80, and to apply light to the light absorption film 84 to transfer the thermal transfer foil 82 onto the transfer object 80. The moving controller 91 causes the carriage 21 to move along the X axis, the Y axis, and the Z axis to cause the pressing body 66 to move. The moving controller 91 is controlled based on foil transfer data. The foil transfer data is data of a figure and a character, for example, input by a user, and examples of the foil transfer data include image data in a vector format and image data in a raster format.

The fan controller 92 is configured or programmed not to drive the fan 70 if the temperature of the light source 62 measured by the temperature measurement device 75 is less than a first temperature (e.g., about 25° C.). Since the fan 70 is not driven, heat generated by the light source 62 itself gradually increases the temperature of the light source 62. The fan controller 92 is configured or programmed to drive the fan 70 if the temperature of the light source 62 measured by the temperature measurement device 75 is the first temperature or more. In this manner, the light source 62 is able to be cooled, and an increase in temperature of the light source 62 is able to be reduced or prevented. The first temperature may be set at any intended value based on performance of the light source 62.

The light source controller 93 controls switching between application (on) and non-application (off) of laser light from the light source 62. The light source controller 93 controls energy of laser light from the light source 62, for example. The light source controller 93 is configured or programmed to stop driving of the light source 62 if the temperature of the light source 62 measured by the temperature measurement device 75 is higher than a second temperature (e.g., about 50° C.) that is higher than the first temperature. In the case of using a laser diode as the light source 62, if the temperature of the light source 62 exceeds about 85° C., for example, problems might occur in the light source 62. Thus, driving of the light source 62 is stopped before the measured temperature reaches a temperature at which problems can occur in the light source 62. When the light source controller 93 stops driving of the light source 62, the moving controller 91 preferably also stops movement of the pressing body moving mechanism 22. The second temperature may be set at any intended value based on performance of the light source 62.

The notifier 94 issues a notification of a temperature abnormality of the light source 62 when the light source controller 93 stops driving of the light source 62. The notification is not limited to a specific method, and may be, for example, a visual display or sound. In this preferred embodiment, an operator is visually notified by a display device (not shown) connected to the thermal transfer apparatus 10.

As described above, the thermal transfer apparatus 10 according to this preferred embodiment includes the fan 70 that sends air to the light source 62 with a light output that varies depending on the temperature. Thus, air can be sent toward the light source 62 during transfer to enable cooling of the light source 62. Accordingly, an increase in temperature of the light source 62 is able to be reduced or prevented, and thus, the temperature of the light source 62 itself during transfer is able to be maintained within a predetermined temperature range. As a result, an output of the light source 62 is able to be maintained constant or substantially constant, and thus, the heat transfer foil 82 is able to be more accurately transferred onto the transfer object 80.

In the thermal transfer apparatus 10 according to this preferred embodiment, the light source 62 is a laser diode. The laser diode has a property in which the amount of heat generation is relatively large and an output easily decrease with a temperature increase. In this preferred embodiment, however, the laser diode is able to be effectively cooled by the fan 70, and thus, the temperature increase of the laser diode itself is able to be reduced or prevented so that a decrease in output of the laser diode is able to be prevented.

In the thermal transfer apparatus 10 according to this preferred embodiment, the light source 62 is disposed on the elevation base 33 that moves up and down relative to the fixture 20 together with the carriage 21. When the elevation base 33 moves downward, the pressing body 66 presses the thermal transfer foil 82 placed on the transfer object 80. During transfer, since the elevation base 33 moves downward, space around the light source 62 enlarges. Accordingly, effective convection of air is able to be performed around the light source 62 by the fan 70 so that the effect of cooling the light source 62 is enhanced.

In the thermal transfer apparatus 10 according to this preferred embodiment, the fan 70 is provided at a side of the light source 62 and in the housing 12. Since the fan 70 is able to be provided in the housing 12, a relatively large fan can be used. In addition, flexibility in the location at which the fan 70 is located is enhanced.

In the thermal transfer apparatus 10 according to this preferred embodiment, the fan 70 may be disposed at a side of the light source 62 and on the elevation base 33. Accordingly, air from the fan 70 is able to be efficiently sent to the light source 62.

In the thermal transfer apparatus 10 according to this preferred embodiment, the light source 62 is housed in the metal case 55 disposed on the elevation base 33. In this manner, heat dissipation of the light source 62 is enhanced.

In the thermal transfer apparatus 10 according to this preferred embodiment, the pressing body 66 is detachably provided on the front end of the pen body 61. Since the pressing body 66 is used while being in contact with the thermal transfer foil 82, the pressing body 66 is gradually abraded. In this preferred embodiment, it is necessary to replace only the pressing body 66, and thus, replacement is able to be performed easily at low costs, as compared to the case of replacing the entire foil transfer tool 60.

In the thermal transfer apparatus 10 according to this preferred embodiment, the fan controller 92 does not drive the fan 70 if the temperature of the light source 62 measured by the temperature measurement device 75 is less than the first temperature. Accordingly, the temperature of the light source 62 itself is able to be increased by heat generation by the light source 62 itself, and the temperature of the light source 62 is able to be maintained at an appropriate temperature so that a light output is performed at an appropriate level. The fan controller 92 drives the fan 70 if the temperature of the light source 62 measured by the temperature measurement device 75 is the first temperature or more. In this manner, the light source 62 is able to be cooled, and a light output of the light source 62 is provided at an appropriate level.

In the thermal transfer apparatus 10 according to this preferred embodiment, the light source controller 93 stops driving of the light source 62 if the temperature of the light source 62 measured by the temperature measurement device 75 is the second temperature or more, wherein the second temperature is higher than the first temperature. For example, if the temperature of the light source 62 increases to the second temperature or more because of a problem occurring in the fan 70, the possibility of a failure increases in the light source 62. Thus, if the temperature of the light source 62 is the second temperature or more, driving of the light source 62 is stopped so that occurrence of a failure in the light source 62 is able to be prevented or reduced.

In the thermal transfer apparatus 10 according to this preferred embodiment, when the light source controller 93 stops driving of the light source 62, the notifier 94 notifies of temperature abnormality in the light source 62. In this manner, an operator is able to be notified of the possibility of occurrence of a failure in the light source 62 or the fan 70, for example.

The thermal transfer apparatus 10 according to the present preferred embodiment includes the DC-to-DC converter 106 disposed downstream of the switch element 104 and reduces the first voltage obtained by conversion in the AC-to-DC converter 102 to the second voltage lower than the first voltage. The light source 62 is disposed downstream of the DC-to-DC converter 106 and is supplied with the second voltage generated by the DC-to-DC converter 106. When the switch element 104 is turned on or off, noise such as chattering or break-in current can occur. The light source 62 is vulnerable to such noise, when the noise in the switch element 104 flows in the light source 62, a failure might occur in the light source 62. In this preferred embodiment, however, since the DC-to-DC converter 106 is disposed between the light source 62 and the switch element 104, the noise is absorbed in the DC-to-DC converter 106, and the constant second voltage from the DC-to-DC converter 106 is constantly supplied to the light source 62. As a result, it is possible to prevent or reduce a failure due to the noise from occurring in the light source 62.

The foregoing description is directed to the preferred embodiments of the present invention. The preferred embodiments described above, however, are merely examples, and the present invention can be performed in various modes.

In the preferred embodiments described above, the pressing body 66 of the foil transfer tool 60 moves relative to the fixture 20, for example. However, the present invention is not limited to this example. In the thermal transfer apparatus 10, the fixture 20 may move relative to the pressing body 66 or both the fixture 20 and the pressing body 66 may be movable. For example, the fixture 20 may be movable along the X axis with the pressing body 66 being movable along the Y axis and the Z axis.

In the preferred embodiments described above, the pressing body 66 preferably is a sphere, for example. The pressing body 66, however, is not limited to this shape. For example, the pressing body 66 may be a hemisphere or a rectangular parallelepiped.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A thermal transfer apparatus comprising:
a stand that holds a transfer object;
a foil transfer tool including:
a pressing body that presses thermal transfer foil placed on the transfer object; and
a light source with a light output that varies depending on a temperature and supplies heat to the thermal transfer foil pressed by the pressing body, the foil transfer tool being structured to transfer the thermal transfer foil onto the transfer object;
a moving mechanism that moves one of the stand and the pressing body relative to another of the stand and the pressing body; and
a fan that sends air to the light source.

2. The thermal transfer apparatus according to claim 1, wherein the light source is a laser diode.

3. The thermal transfer apparatus according to claim 1, further comprising a housing that houses the moving mechanism, wherein the foil transfer tool includes:
a hollow pen body including a front end; and
a light guide including a first end and a second end and at least partially disposed in the pen body; wherein
the light source is connected to the first end of the light guide;
the pressing body is disposed at the front end of the pen body and made of a material through which light from the light source passes;
the second end of the light guide is disposed at the front end of the pen body to face the pressing body in the pen body;
the moving mechanism includes a carriage that holds the pen body and moves relative to the stand and a base member that is disposed above the carriage and moves up and down relative to the stand together with the carriage;
the light source is disposed on the base member; and
when the base member moves downward, the pressing body presses the thermal transfer foil placed on the transfer object.

4. The thermal transfer apparatus according to claim 3, wherein the fan is disposed at a side of the light source and in the housing.

5. The thermal transfer apparatus according to claim 3, wherein the fan is disposed at a side of the light source and on the base member.

6. The thermal transfer apparatus according to claim 3, wherein the light source is housed in a metal case disposed on the base member.

7. The thermal transfer apparatus according to claim 3, wherein the pressing body is detachably disposed at the front end of the pen body.

8. The thermal transfer apparatus according to claim 1, further comprising:
a temperature measurement device that measures a temperature of the light source; and
a controller that controls the light source and the fan; wherein
the controller includes a fan controller that does not drive the fan if a temperature of the light source measured by the temperature measurement device is less than a first temperature and drives the fan if the temperature of the light source measured by the temperature measurement device is the first temperature or more.

9. The thermal transfer apparatus according to claim 8, wherein the controller includes a light source controller that stops driving of the light source if the temperature of the light source measured by the temperature measurement device is greater than or equal to a second temperature that is higher than the first temperature.

10. The thermal transfer apparatus according to claim 9, wherein the controller further includes a notifier that issues a notification of temperature abnormality in the light source when the light source controller stops driving of the light source.

11. The thermal transfer apparatus according to claim 1, further comprising:
an AC-to-DC converter that converts an alternating current from a commercial power supply to a first voltage for a direct current;
a switch element disposed downstream of the AC-to-DC converter; and
a DC-to-DC converter disposed downstream of the switch element and reduces the first voltage to a second voltage that is lower than the first voltage; wherein
the light source is disposed downstream of the DC-to-DC converter; and
the light source is supplied with the second voltage generated by the DC-to-DC converter.
